(19) United States
(12) Patent Application Publication
(10) Pub. No.: US 2024/0373510 A1
(43) Pub. Date: Nov. 7, 2024

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/778,219

(22) Filed: Jul. 19, 2024

Related U.S. Application Data
(63) Continuation of application No. PCT/JP2023/001315, filed on Jan. 18, 2023.
(60) Provisional application No. 63/301,803, filed on Jan. 21, 2022.

(51) Int. Cl. H04W 76/40; H04W 76/14; H04W 88/04

(52) U.S. Cl. CPC H04W 76/40; H04W 76/14; H04W 88/04

(57) ABSTRACT

A communication method for transmitting multicast broadcast service (MBS) data belonging to an MBS session from a network node to a remote user equipment via a relay user equipment, the communication method including a step of receiving, by a relay user equipment, an MBS session start notification indicating start of an MBS session from a network node, and a step of transmitting, by the relay user equipment, an MBS session start information based on the MBS session start notification to a remote user equipment over a sidelink.

### RELATED APPLICATIONS

The present application is a continuation based on PCT Application No. PCT/JP2023/001315, filed on Jan. 18, 2023, which claims the benefit of U.S. Provisional Patent Application No. 63/301,803 filed on Jan. 21, 2022. The content of which is incorporated by reference herein in their entirety.

### TECHNICAL FIELD

The present disclosure relates to a communication method used in a mobile communication system.

### BACKGROUND

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast broadcast services (MBS) of 5G/NR (for example, see Non-Patent Document 1).

In 3GPP, there have been discussions for establishing technical specifications of a Sidelink Relay in which a user equipment is used as a relay node. The sidelink relay is a technology in which a relay node referred to as a relay user equipment (Relay UE) mediates communication between a base station and a remote user equipment (Remote UE) and relays the communication. Here, a communication between the base stations and the relay user equipment is performed over an uplink and a downlink (also called Uu interface), and a communication between the relay user equipment and the remote user equipment performed over a sidelink (also called PC5 interface).

### CITATION LIST

### Non-Patent Literature

Non-Patent Document 1: 3GPP Contribution: RP-201038

### SUMMARY

In a first aspect, a communication method is for transmitting multicast broadcast service (MBS) data belonging to an MBS session from a base station to a remote user equipment via a relay user equipment. The communication method includes a step of receiving, by a relay user equipment, an MBS session start notification indicating start of an MBS session from a base station, and a step of transmitting, by the relay user equipment, an MBS session start information based on the MBS session start notification to a remote user equipment over a sidelink.

In a second aspect, a communication method is for transmitting multicast broadcast service (IBS) data belonging to an MBS session from a base station to a remote user equipment via a relay user equipment. The communication method includes step of receiving, by a remote user equipment, association information in which an identifier indicating an MBS session and a destination layer-2 identifier are associated with each other from a relay user equipment or a base station, and a step of receiving, by the remote user equipment, MBS data belonging to the MBS session from the base station via the relay user equipment based on the association information. The step of receiving the MBS data includes a step of monitoring a sidelink shared channel (SL-SCH) using the destination layer-2 identifier associated with the MBS session.

In a third, a communication method is for transmitting multicast broadcast service (MIBS) data belonging to an MBS session from a base station to a remote user equipment via a relay user equipment. The communication method includes a step of receiving, by a remote user equipment and/or a relay user equipment, association information in which a ProSe layer-2 group identifier or an application layer group identifier is associated with an identifier indicating an MBS session from a core network apparatus or a server apparatus, and a step of specifying, by the remote user equipment and/or the relay user equipment, a destination layer-2 identifier associated with the MBS session based on the association information.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of IBS traffic delivery according to an embodiment.

FIG. 7 is a diagram illustrating delivery modes according to an embodiment.

FIG. 8 is a diagram illustrating an example of internal processing related to IBS reception of a UE according to an embodiment.

FIG. 9 is a diagram illustrating another example of internal processing related to the MBS reception of the UE according to an embodiment.

FIG. 10 is a diagram illustrating a sidelink according to an embodiment.

FIG. 11 is a diagram illustrating a configuration of a radio protocol for sidelink communication according to an embodiment.

FIG. 12 is a diagram illustrating an example of sidelink relay according to an embodiment.

FIG. 13 is a diagram illustrating an example of a protocol stack of a user plane in a sidelink relay according to an embodiment.

FIG. 14 is a diagram illustrating an example of a protocol stack of a control plane in a sidelink relay according to an embodiment.

FIG. 15 is a diagram illustrating of an MBS transfer using a sidelink relay according to an embodiment.

FIG. 16 is a diagram illustrating a transfer operation of a session start notification according to an embodiment.

FIG. 17 is a diagram illustrating an operation example related to the session start notification according to an embodiment.

FIG. 18 is a diagram illustrating a variation of the operation illustrated in FIG. 17.

FIG. 19 is a diagram illustrating a first operation example of an MBS data transmission in the sidelink according to an embodiment.

FIG. 20 is a diagram illustrating a second operation example of the MBS data transmission in the sidelink according to an embodiment.

FIG. 21 is a diagram illustrating an example of a relay UE selection operation by a remote UE according to an embodiment.

FIG. 22 is a diagram illustrating an operation example related to an RRC connection operation by a relay UE according to an embodiment.

FIG. 23 is a diagram illustrating a handover operation of the relay UE according to an embodiment.

FIG. 24 is a diagram illustrating a first operation example of a handover of the relay UE according to an embodiment.

FIG. 25 is a diagram illustrating a second operation example of the handover of the relay UE according to an embodiment.

FIG. 26 is a diagram illustrating a third operation example of the handover of the relay UE according to an embodiment.

### DESCRIPTION OF EMBODIMENTS

Multicast broadcast services (MBS) may be improved by combining with a sidelink relay. For example, even a remote user equipment outside a coverage of a base station can receive MBS data via a relay user equipment by the relay user equipment transferring the MBS data from the base station to the remote user equipment. However, no mechanism for combining the MBS with the sidelink relay exists in the current 3GPP technical specifications.

The present disclosure provides an improved multicast broadcast service.

A mobile communication system according to an embodiment is described with reference to the drawings. In the description of the drawings, the same or similar parts are denoted by the same or similar reference signs.

### (1) Configuration of Mobile Communication System

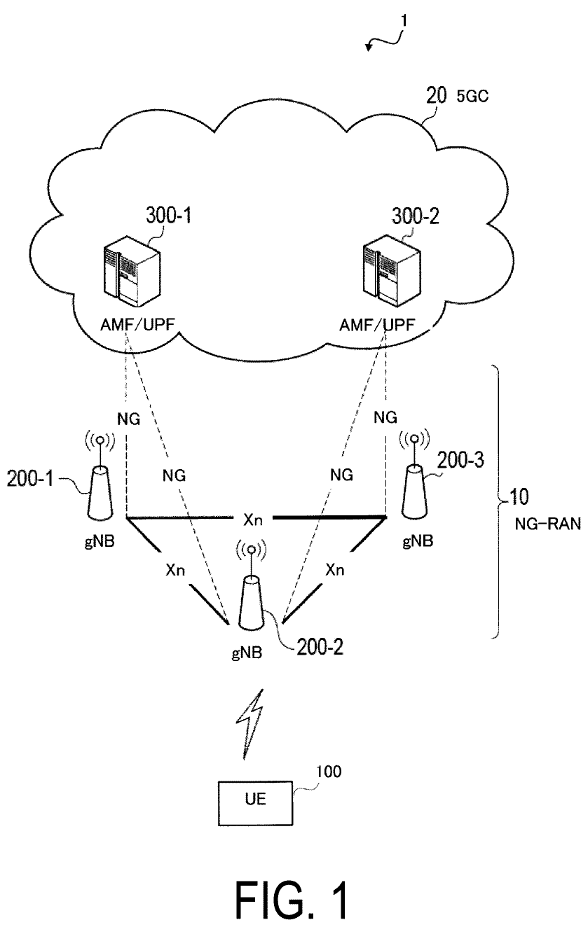

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200.

The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

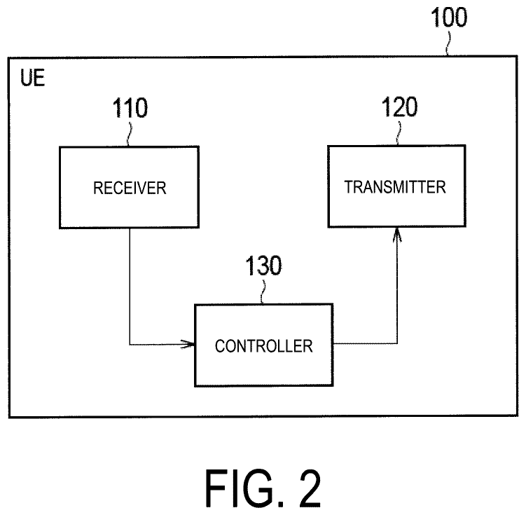

FIG. 2 is a diagram illustrating a configuration of the UE 100 (user equipment) to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the resulting signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

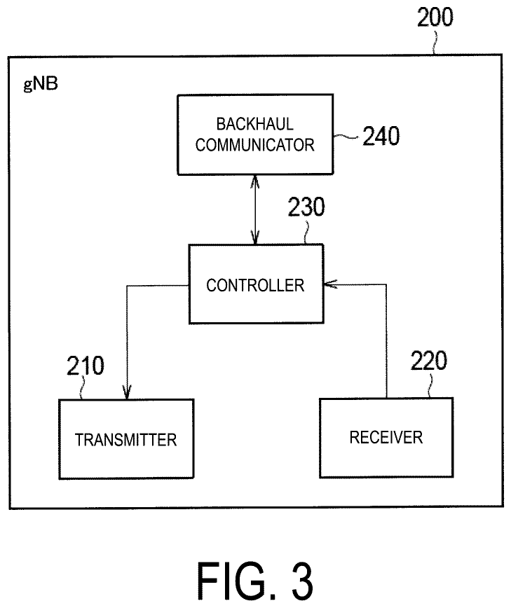

FIG. 3 is a diagram illustrating a configuration of the gNB 200 (base station) according to the embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

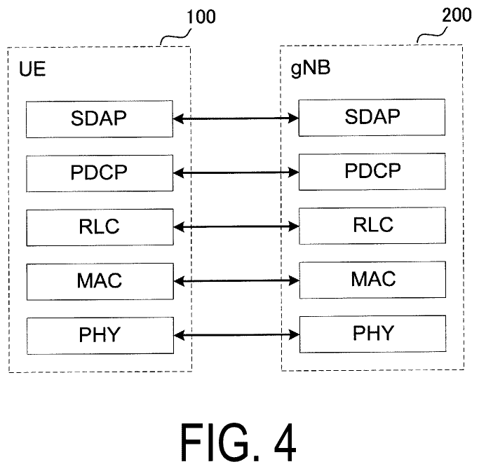

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCS)) in the uplink and the downlink, and resource blocks to be allocated to the UE 100.

The RLC layer transmits data to a reception-side RLC layer by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of QoS control performed by a core network and a radio bearer as the unit of QoS control performed by an Access Stratum (AS). Note that, when the RAN is connected to the EPC, the SDAP need not be provided.

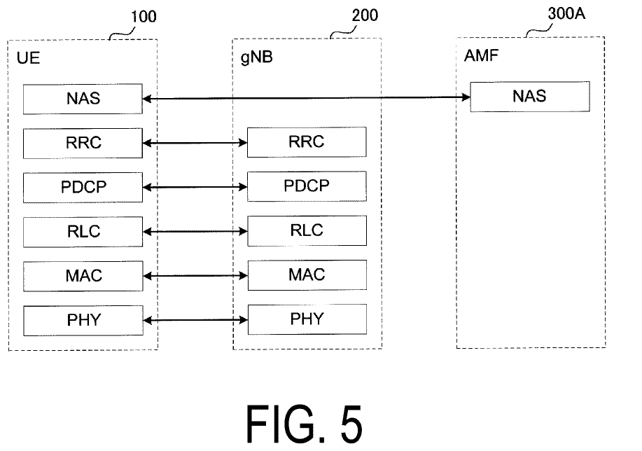

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300A. Note that the UE 100 includes an application layer other than the protocol of the radio interface. A layer lower than the NAS layer is referred to as an AS layer.

### (2) Overview of MBS

An overview of the MBS is described according to the present embodiment. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet protocol television (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 joining the multicast service (multicast session). An MBS session used for the multicast service is referred to as a multicast session. The multicast service can provide the same content to the group of UEs 100 through a method with higher radio efficiency than the broadcast service.

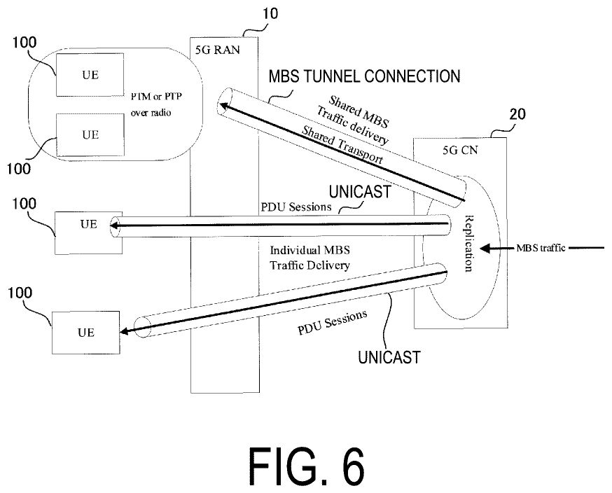

FIG. 6 is a diagram illustrating an overview of MBS traffic delivery according to the embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via Protocol Data Unit (PDU) sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

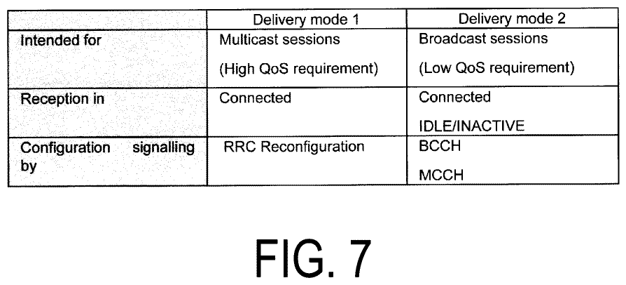

FIG. 7 is a diagram illustrating delivery modes according to the embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or RRC Release message), which is an RRC message transmitted from the gNB 200 to the UE 100 by unicast.

The MBS reception configuration includes MBS traffic channel configuration information (hereinafter referred to as “MTCH configuration information”) about configuration of an MBS traffic channel transmitting MBS data. The MTCH configuration information includes MBS session information (including an MBS session identifier described below) relating to an MBS session and scheduling information of the MBS traffic channel corresponding to the MBS session. The scheduling information of an MBS traffic channel may include discontinuous reception (DRX) configuration of the MBS traffic channel. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The LE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. First, the UE 100 receives MCCH configuration information on a SIB (MBS SIB) transmitted from the gNB 200 on the BCCH. Second, the UE 100 receives the MCCH from the gNB 200, based on the MCCH configuration information. On the MCCH, MTCH configuration information is transmitted. Third, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the source specific IP multicast address, and the session identifier is referred to as an MBS session identifier. The TMGI, the source-specific IP multicast address, the session identifier, and the G-RNTI are collectively referred to as MBS session information.

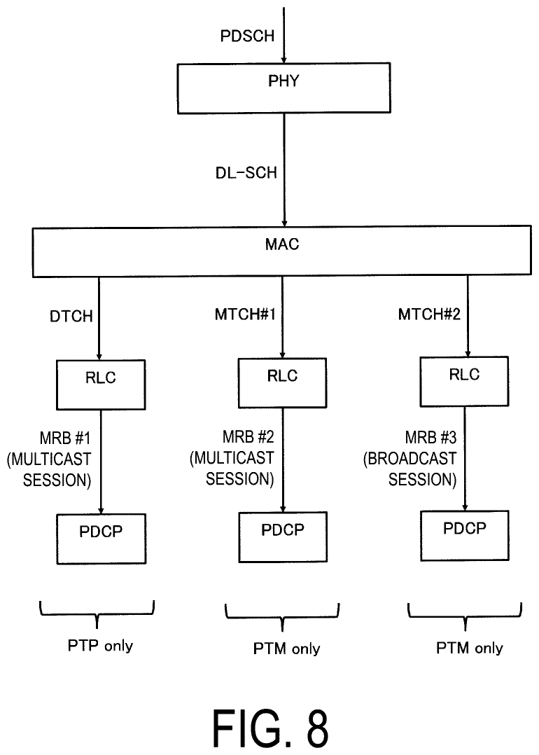

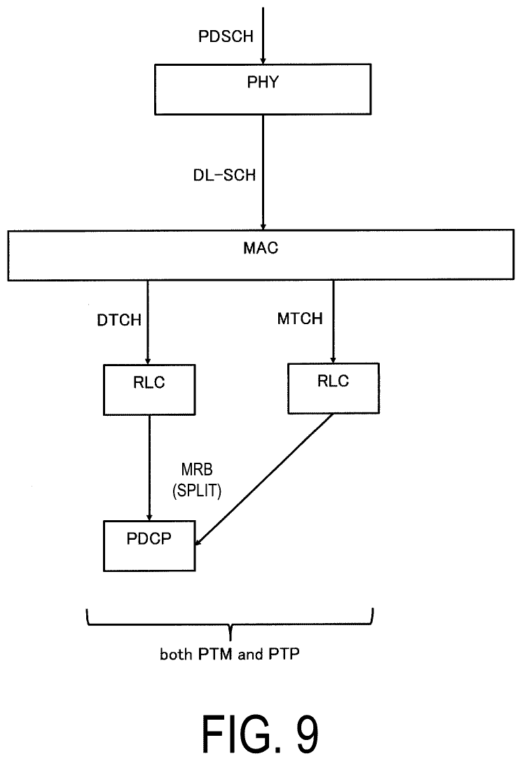

FIG. 8 is a diagram illustrating an example of internal processing related to the MBS reception of the UE 100 according to an embodiment. FIG. 9 is a diagram illustrating another example of the internal processing related to the MBS reception of the UE 100 according to an embodiment.

One MBS radio bearer (MRB) is one radio bearer transmitting a multicast session or a broadcast session. That is, a multicast session may be associated with an MRB or a broadcast session may be associated with an MRB.

The MRB and the corresponding logical channel (e.g., MTCH) are configured for the UE 100 from the gNB 200 through RRC signaling. An MRB configuration procedure may be separated from a data radio bearer (DRB) configuration procedure. In the RRC signaling, one MRB can be configured with “PTM only”, “PTP only”, or “both PTM and PTP”. The type of MRB may be changed by the RRC signaling.

FIG. 8 illustrates an example in which a multicast session and a dedicated traffic channel (DTCH) are associated with an MRB #1, a multicast session and an MTCH #1 are associated with an MRB #2, and a broadcast session and an MTCH #2 are associated with an MRB #3. That is, the MRB #1 is configured with PTP only MRB, the MRB #2 is configured with PTM only MRB, and the MRB #3 is configured with PTM only MRB. Note that the DTCH is scheduled using a cell RNTI (C-RNTI). The MTCH is scheduled using the G-RNTI.

The PHY layer of the UE 100 processes user data (received data) received on the PDSCH, which is one of physical channels, and routes the processed user data to the downlink shared channel (DL-SCH), which is one of transport channels. The MAC layer (MAC entity) of the UE 100 processes the data received on the DL-SCH and routes the received data to a corresponding logical channel (corresponding RLC entity) based on a logical channel identifier (LC ID) included in the header (MAC header) included in the received data.

FIG. 9 illustrates an example in which the DTCH and the MTCH are associated with the MRB associated with the multicast session. Specifically, one MRB is split into two legs, one leg is associated with the DTCH, and the other leg is associated with the MTCH. The two legs are combined at the PDCP layer (PDCP entity). That is, the MRB is an MRB configured with both PTM and PTP. Such an MRB may be referred to as a split MRB.

### (3) Overview of Sidelink

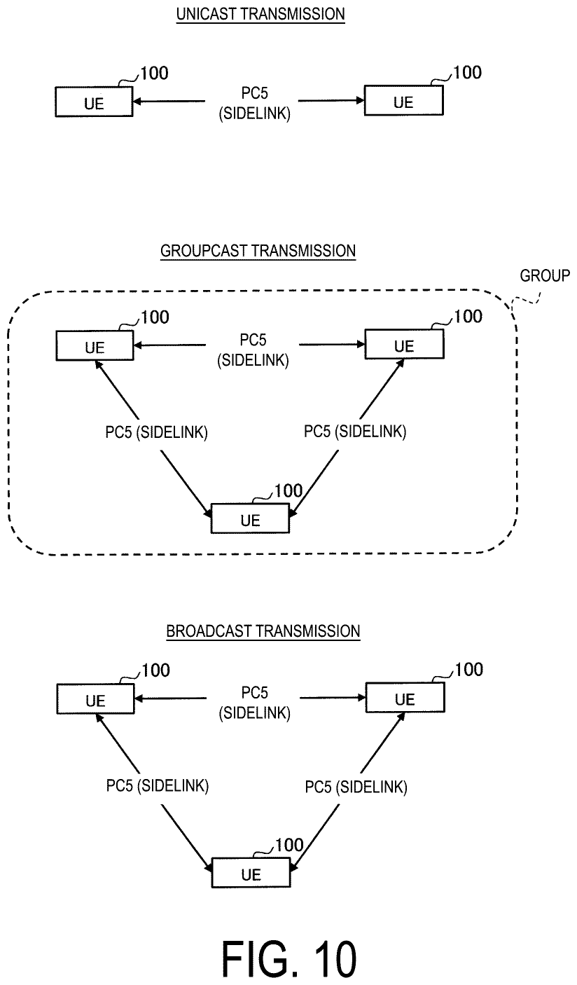

An overview of a sidelink is described according to an embodiment. FIG. 10 is a diagram illustrating the sidelink according to an embodiment.

The sidelink is a direct interface between the UEs 100 and is provided on a PC5 interface. The UE 100 may be within the coverage of the gNB 200 (RAN 10). The UE 100 may also be outside the coverage of the gNB 200 (RAN 10). The RRC state of the UE 100 may be any state (RRC connected state, RRC idle state, or RRC inactive state).

The sidelink is used for a sidelink communication. In the sidelink communication, a plurality of adjacent UEs 100 perform data transmission without through a network node. The sidelink is also used for sidelink discovery. The sidelink discovery is for the UE 100 to discover another UE 100 in the vicinity. The sidelink communication is mainly described below.

The sidelink communication can support any one of a total of three transmission modes of unicast transmission, groupcast transmission, and broadcast transmission for a pair of source layer-2 identifier (Source Layer-2 ID) and destination layer-2 identifier (Destination Layer-2 ID) in the AS.

In the unicast transmission, one PC5-RRC connection is supported between two peer UEs constituting a pair of UEs, and control information and user data are transmitted and received between the peer UEs in the sidelink. The PC5-RRC connection is a logical connection between two UEs for the pair of source layer-2 identifier and destination layer-2 identifier that is considered to be established after a corresponding PC5 unicast link is established. The PC5-RRC connection and the PC5 unicast link have a one-to-one relationship. The UE 100 may have a plurality of PC5-RRC connections with one or more UEs for different pairs of source layer-2 identifier and destination layer-2 identifier. In the unicast transmission, sidelink HARQ feedback, sidelink transmit power control, RLC AM (Acknowledge Mode), and detection of radio link failure of PC5-RRC connection are supported.

In the groupcast transmission, user data is transmitted and received between the UEs belonging to a group in the sidelink. In the groupcast, sidelink HARQ feedback is supported.

In the broadcast transmission, user data is transmitted and received between the UEs in the sidelink.

Here, the source layer-2 identifier (Source Layer-2 ID) is an identifier for identifying a source of data in the sidelink communication. For example, the source layer-2 identifier is 24 bits long and is split into two bit strings in the MAC layer. One bit string is an LSB portion (8 bits) of the source layer-2 identifier and is transferred to a transmission-side physical layer. This is used to identify the source of the intended data in the sidelink control information and to filter the packets in the reception-side physical layer. The other bit string is an MSB portion (16 bits) of the source layer-2 identifier and is transmitted in the MAC header. This is used to filter the packets in the reception-side MAC layer.

The destination layer-2 identifier (Destination Layer-2 ID) is an identifier for identifying a target of data in the sidelink communication. For example, the destination layer-2 identifier is 24 bits long and is split into two bit strings in the MAC layer. One bit string is the LSB portion (16 bits) of the destination layer-2 identifier and is transferred to the transmission-side physical layer. This is used to identify the target of the intended data in the sidelink control information and to filter the packets in the reception-side physical layer. The other bit string is the MSB part (8 bits) of the destination layer-2 identifier and is transmitted in the MAC header. This is used to filter the packets in the reception-side MAC layer.

In the sidelink communication, a MAC sublayer performs radio resource selection, packet filtering, priority processing between uplink transmission and sidelink transmission, and sidelink Channel State Information (CSI) reporting. For the packet filtering, a SL-SCH MAC header including portions of both the source layer-2 identifier and the destination layer-2 identifier is added to each MAC Protocol Data Unit (PDU). The LCID included in a MAC subheader uniquely identifies the logical channel within the combination of the source layer-2 identifier and the destination layer-2 identifier.

The following logical channels are used in the sidelink.
Sidelink Control Channel (SCCH): A sidelink channel for transmitting control information (PC5-RRC messages and PC5-S messages) from one ULE to another. The SCCH is mapped to a SL-SCH that is a transport channel.
Sidelink Traffic Channel (STCH): A sidelink channel for transmitting user data from one UE to another UE. The STCH is mapped to a SL-SCH that is a transport channel.
Sidelink Broadcast Control Channel (SBCCH): A sidelink channel for broadcasting sidelink system information from one UE to another UE. The SBCCH is mapped to a SL-BCH that is a transport channel.

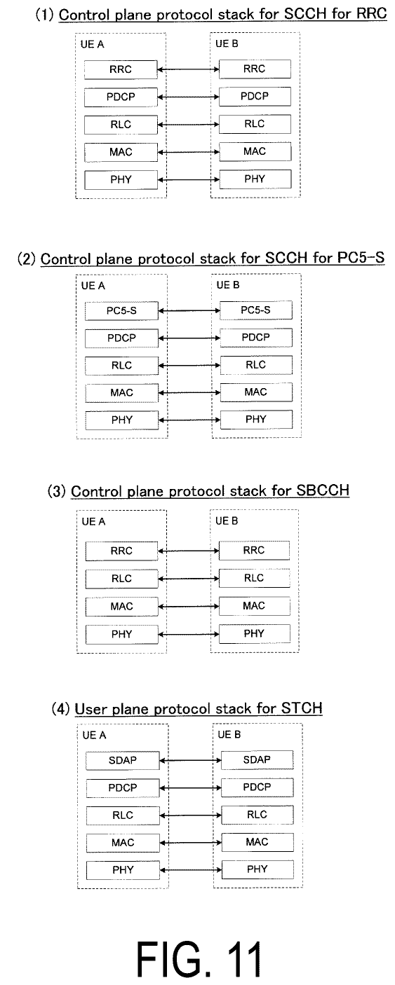

FIG. 11 is a diagram illustrating a configuration of a radio protocol for sidelink communication according to an embodiment.

FIG. 11 illustrates, in (1), the protocol stack of the control plane for the SCCH for the RRC. This protocol stack includes the RRC, PDCP, RLC, MAC and physical (PHY) layers.

FIG. 11 illustrates, in (2), the protocol stack of the control plane for the SCCH for the PC5-S. The PC5-S is located in a layer above the PDCP, RLC, MAC and physical (PHY) layers.

FIG. 11 illustrates, in (3), the protocol stack of the control plane of the SBCCH. This protocol stack includes the RRC, RLC, MAC, and physical (PHY) layers.

FIG. 11 illustrates, in (4), the protocol stack of the user plane for the STCH. This protocol stack includes the SDAP, PDCP, RLC, MAC and physical (PHY) layers.

### (4) Overview of Sidelink Relay

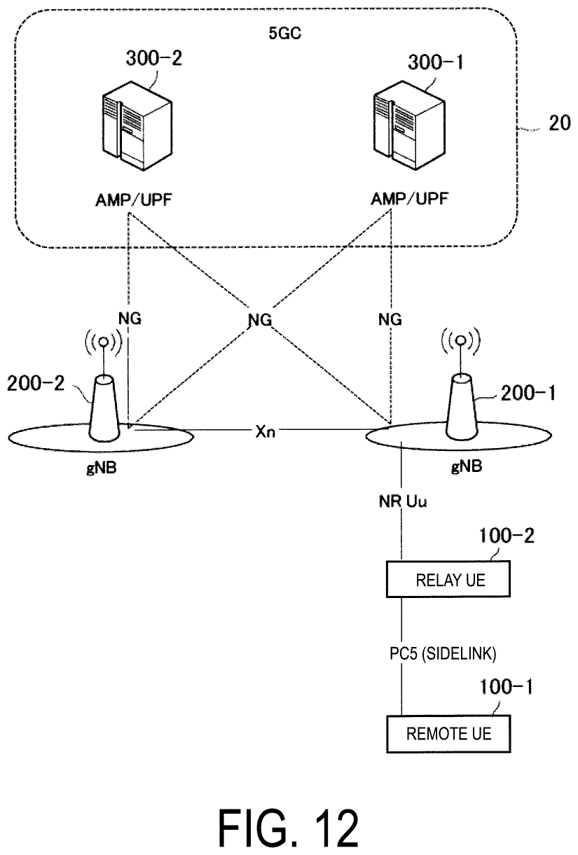

An overview of sidelink relay is described according to an embodiment. FIG. 12 is a diagram illustrating an example of sidelink relay according to an embodiment.

In the sidelink relay, a relay UE 100-2 mediates communication between a gNB 200-1 and a remote UE 100-1, and relay the communication. The remote UE 100-1 communicates with the gNB 200-1 via the relay UE 100-2. The relay UE 100-2 is located within the coverage of the RAN 10 (specifically, gNB 200-1). The remote UE 100-1 is located outside or within the coverage of the RAN 10.

The remote UE 100-1 performs wireless communication (sidelink communication) with the relay UE 100-2 on a PC5 interface (sidelink) used as an inter-UE interface. The relay UE 100-2 performs wireless communication (Uu communication) with the gNB 200-1 on an NR Uu radio interface. As a result, the remote UE 100-1 indirectly communicates with the gNB 200-1 via the relay UE 100-2. The Uu communication includes uplink communication and downlink communication.

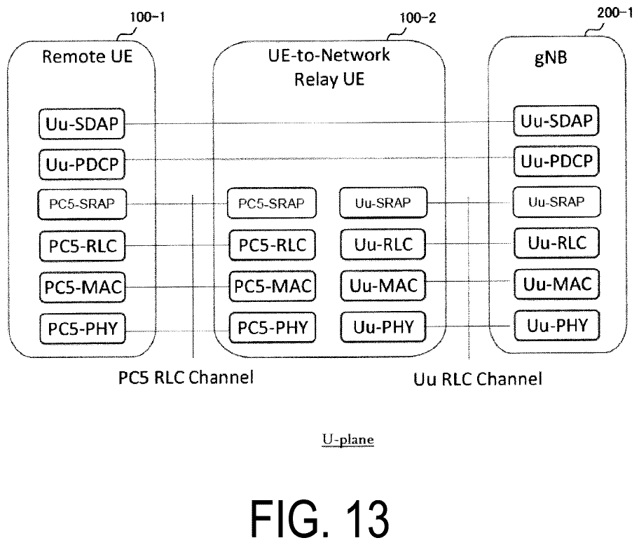

FIG. 13 is a diagram illustrating an example of the protocol stack of the user plane in the sidelink relay according to an embodiment. The figure is also an example of the protocol stack of the user plane in relay via the relay UE 100-2 (i.e., U2N (UE to Network) relay).

The gNB 200-1 includes a Uu-SRAP (sidelink relay adaptation protocol) layer, a Uu-RLC layer, a Uu-MAC layer, and a Uu-PHY layer which are used for communication on the NR Uu interface (Uu communication).

The relay UE 100-2 includes a Uu-SRAP layer, a Uu-RLC layer, a Uu-MAC layer, and a Uu-PHY layer which are used for communication on the NR Uu interface (Uu communication). The relay UE 100-2 includes a PC5-SRAP layer, a PC5-RLC layer, a PC5-MAC layer, and a PC5-PHY layer which are used for communication on the PC5 interface (PC5 communication).

The remote UE 100-1 includes a Uu-SDAP layer and a Uu-PDCP layer which are used for communication on a Uu interface (Uu). The remote UE 100-1 includes a PC5-SRAP layer, a PC5-RLC layer, a PC5-MAC layer (PC5), and a PC5-PHY layer which are used for communication on the PC5 interface (PC5 communication).

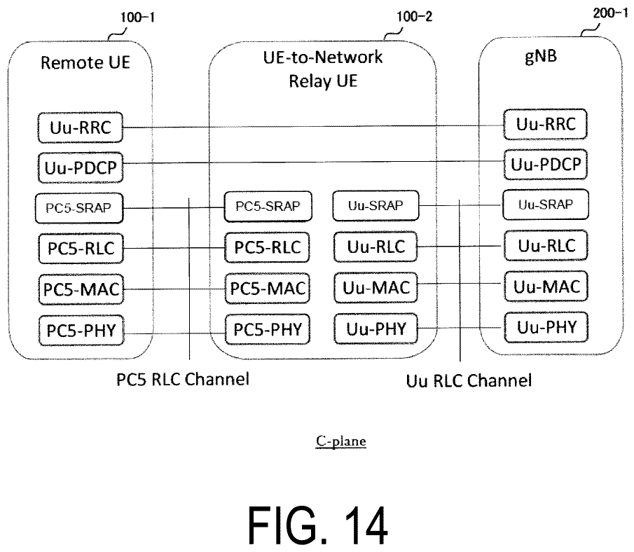

FIG. 14 is a diagram illustrating an example of the protocol stack of the control plane in the sidelink relay according to an embodiment. The figure is also an example of the protocol stack of the control plane in the U2N relay.

In the control plane, the Uu-RRC layer is arranged instead of the Uu-SDAP layer of the user plane.

As illustrated in FIGS. 13 and 14, the SRAP layers are arranged on the Uu interface and the PC5 interface. The SRAP layer is an example of a so-called adaptation layer. The SRAP layer is present only in a layer-2 relay and does not exist in a layer-3 relay. The SRAP layer is present in all of the remote UE 100-1, the relay UE 100-2, and the gNB 200-1. The SRAP layer includes two layers of PC5-SRAP and Uu-SRAP. The PC5-SRAP and the Uu-SRAP have bearer mapping functions. For example, the bearer mapping function is as follows. That is, the remote UE 100-1 and the Uu-SRAP of the gNB 200-1 perform mapping between the bearer (Uu-PDCP) and the PC5 RLC channel (PC5-RLC). The PC5-SRAP of the relay UE 100-2 and the Uu-SRAP perform mapping between the PC5 RLC channel (PC5-RLC) and the Uu RLC channel (Uu-RLC). The Uu-SRAP has an identification function of the remote UE 100-1.

Note that, as described above, each of the remote UE 100-1 and the relay UE 100-2 may include an RRC layer for PC5. Such an RRC layer is referred to as a “PC5-RRC layer”. The PC5-RRC connection and the PC5 unicast link between the remote UE 100-1 and the relay UE 100-2 are in a one-to-one correspondence, and the PC5-RRC connection is established after the PC5 unicast link is established.

As described above, each of the remote UE 100-1 and the relay UE 100-2 may include a PC5-S (signaling) protocol layer. The PC5-S protocol layer is an upper layer of the PDCP layer. Like the PC5-RRC layer, the PC5-S protocol layer is also a layer for transmitting the control information.

### (5) MBS Transfer Using Sidelink Relay

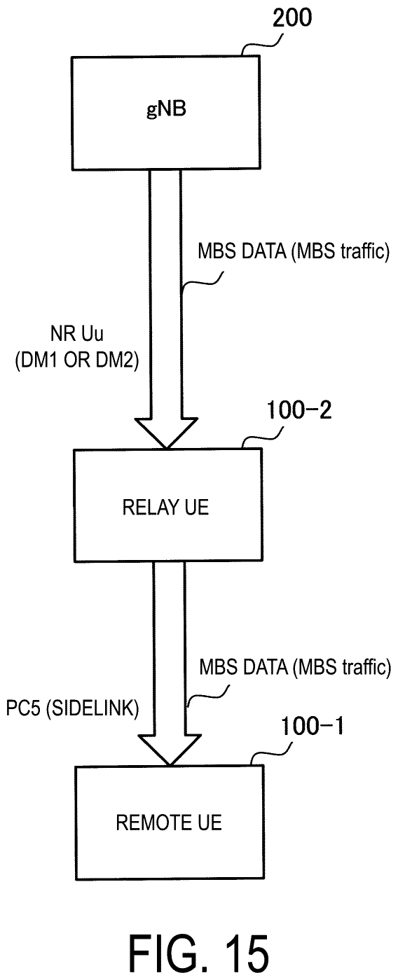

An MBS transfer using a sidelink relay is described according to an embodiment. FIG. 15 is a diagram illustrating of the MBS transfer using the sidelink relay according to an embodiment.

In the embodiment, the MBS is combined with the sidelink relay. For example, the relay UE 100-2 transfers the MBS data from gNB 200 to the remote UE 100-1. Thus, even the remote UE 100-1 outside the coverage of the gNB 200 can receive the MBS data via the relay UE 100-2.

For MBS data relay, first, the relay UE 100-2 receives MBS data belonging to an MBS session from the gNB 200 on the downlink (Uu interface). The MBS delivery mode between the gNB 200 and the relay UE 100-2 may be the first delivery mode (DM 1) or the second delivery mode (DM 2). The MRB from the gNB 200 to the relay UE 100-2 may be PTM, PTP, or split bearer (split MRB). The MRB data from the gNB 200 to the relay UE 100-2 may be transmitted in data radio bearer (DRB), that is, by unicast. Second, the relay UE 100-2 transmits (transfers) the MBS data received from the gNB 200 to the remote UE 100-1 over the sidelink (PC5 interface). The sidelink transmission mode from the relay UE 100-2 to the remote UE 100-1 may be unicast, groupcast or broadcast.

Various operations in MBS transmission using sidelink relay is described below. Note that the following description mainly describes an example in which the TMGI is used as the MBS session identifier, but at least one selected from the group consisting of the source specific IP multicast address, the session identifier, and the G-RNTI may be used as the MBS session identifier.

### (5.1) Transfer Operation of Session Start Notification

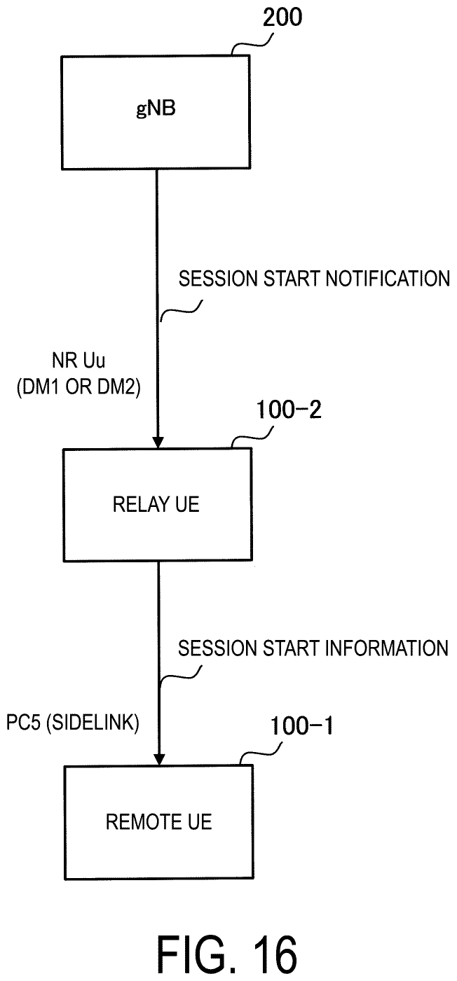

A transfer operation of a session start notification is described according to the embodiment. FIG. 16 is a diagram illustrating the transfer operation of the session start notification according to an embodiment.

As illustrated in FIG. 16, the relay UE 100-2 receives an MBS session start notification indicating start of the MBS session from the gNB 200. The relay UE 100-2 transmits MBS session start information based on the MBS session start notification received from the gNB 200 to the remote UE 100-1 over the sidelink. This allows the remote UE 100-1 to grasp the start of the MBS session based on the MBS session start information.

The relay UE 100-2 may receive a paging message including an identifier of the MBS session to be started from the gNB 200 as the MBS session start notification. Such a session start notification may be a paging message including a list of TMGIs of the MBS sessions to be started. Such a paging message may be a paging message used for the first delivery mode (DM 1) and may be a message for notification of multicast session activation in order to invoke a UE 100 joining a multicast session as an MBS session. For example, when a multicast session is started (activated), the gNB 200 transmits a paging message including the TMGI of the multicast session. The start (activation) of the multicast session may be start of transmission of multicast data by multicast session. The start of the target multicast session may be transition to a state in which transmission of the multicast data can be started in the target multicast session.

The relay UE 100-2 may receive an MCCH (multicast control channel) change notification indicating the update of the MCCH and the updated MCCH as the MBS session start notification from the gNB 200. Such an MBS session start notification is used for the second delivery mode (DM 2). The relay UE 100-2 receives the updated MCCH from the gNB 200 in response to receiving the MCCH change notification from the gNB 200. The MCCH includes the TMGI as the MBS session identifier. The updated MCCH may include the TMGI of the broadcast session to be started.

The relay UE 100-2 transmits the MBS session start information based on the MBS session start notification received from the gNB 200 to the remote UE 100-1 over the sidelink. The MBS session start information may include an identifier of the MBS session to be started. This allows the remote UE 100-1 to specify the MBS session to be started. The relay UE 100-2 may transmit a PC5-RRC message including the MBS session start information to the remote UE 100-1. The relay UE 100-2 may transmit a discovery message including the MBS session start information to the remote UE 100-1.

The remote UE 100-1, in response to receiving the MBS session start information from the relay UE 100-2, may avoid reselection of a relay UE 100-2 different from the former relay UE 100-2. For example, the remote UE 100-1 determines that the MBS session (multicast session or broadcast session) that the remote UE 100-1 is interested in receiving is started based on the MBS session start information, and waits for MBS data transfer while maintaining the current relay UE 100-2.

The remote UE 100-1 may start monitoring for sidelink data transmission from the relay UE 100-2 in response to receiving the MBS session start information from the relay UE 100-2. For example, the remote UE 100-1 determines that the MBS session (multicast session or broadcast session) that the remote UE 100-1 is interested in receiving is started based on the MBS session start information, and starts monitoring for sidelink data transmission from the relay UE 100-2. The remote UE 100-1 may stop monitoring for sidelink data transmission from the relay UE 100-2 until the MBS session in which the remote UE 100-1 is interested in receiving is started. This allows the remote UE 100-1 to reduce power consumption and processing load caused by the monitoring.

Note that the relay UE 100-2 may transmit the session start information including the TMGI of the MBS session to the remote UE 100-1 only when the MBS session that the remote UE 100-1 is interested in receiving is started. This can avoid transmitting unnecessary session start information to the remote UE 100-1, and reduce the resource load of the sidelink and the processing load of the remote UE 100-1. For example, the relay UE 100-2 may receive an identifier of a desired MBS session that the remote UE 100 is interested in receiving, from the remote UE 100-1 or the gNB 200-1. The relay UE 100-2 may grasp a start of the desired MBS session based on the session start notification received from the gNB 200, and indicate the start of the desired MBS session to the remote UE 100-1 through the MBS session start information.

The relay UE 100-2 may transfer only a part of the information such as the TMGI to the remote UE 100-1 instead of transferring all the information included in the session start notification received from the gNB 200 to the remote UE 100-1. For example, the relay UE 100-2 may not need to transmit the MTCH scheduling information received on the MCCH from the gNB 200 to the remote UE 100-1. This can suppress an information amount of the session start information, and reduce the resource load of the sidelink and the processing load of the remote UE 100-1. Note that the relay UE 100-2 may transfer neighboring cell information received from the gNB 200 on the MCCH to the remote UE 100-1 for MBS service continuity.

The relay UE 100-2 may also receive a layer-2 identifier assigned to the remote UE 100-1 interested in receiving the MBS session, from the gNB 200. The relay UE 100-2 may transmit the MBS session start information to the remote UE 100-1 using the layer-2 identifier.

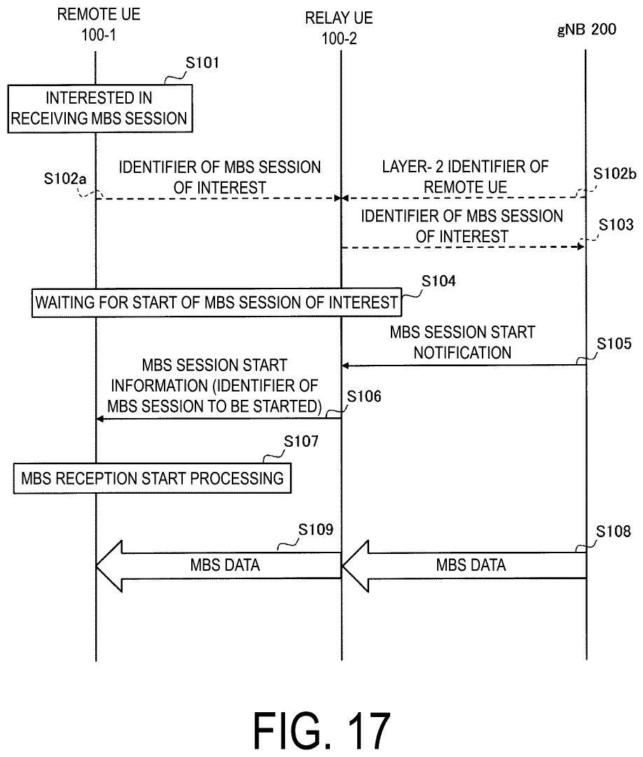

FIG. 17 is a diagram illustrating an operation example related to the session start notification according to an embodiment. The relay UE 100-2 may be in the RRC connected state, the RRC inactive state, or the RRC idle state with respect to the gNB 200.

In step S101, the remote UE 100-1 is interested in receiving an MBS session. For the multicast, the remote UE 100-1 may be in a state of already joining the multicast session. Note that “joining a multicast session” may be registering the UE 100, as a member of a UE group (multicast group) that receives the multicast session, in the CN 20 (CN apparatus).

In step S102a, the remote UE 100-1 may transmit the identifier (TMGI) of the MBS session in which the remote UE 100-1 is interested, as MBS interest information, to the relay UE 100-2. For example, the remote UE 100-1 may transmit a PC5-RRC message (or discovery message) including the identifier (TMGI) of the MBS session in which the remote UE 100-1 is interested to the relay UE 100-2. The relay UE 100-2 may store the TMGI and the layer-2 identifier of the remote UE 100-1 in association with each other.

In step S102b, the gNB 200 may transmit a message including the layer-2 identifier of the remote UE 100-1 interested in the MBS session to the relay UE 100-2. The relay UE 100-2 may store the TMGI of the MBS session and the layer-2 identifier of the remote UE 100-1 in association with each other.

In step S103, the relay UE 100-2 may transmit a notification including the identifier (TMGI) of the MBS session in which the remote UE 100-1 is interested to the gNB 200-1 in order to receive the MBS session start notification (e.g., a paging message). Such a notification may be an MBS Interest Indication (MII). Such a notification may be a UE Assistance Information. For the multicast, the relay UE 100-2 may join the multicast session in which the remote UE 100-1 is interested in order to receive the MBS session start notification (e.g., paging message).

In step S104, the remote UE 100-1 and the relay UE 100-2 wait for MBS session start. The remote UE 100-1 may be in the RRC connected state, the RRC inactive state, or the RRC idle state with respect to the gNB 200. The remote UE 100-1 may be in the PC5-RRC connected state or the PC5-RRC idle state with respect to the relay UE 100-2.

In step S105, the relay UE 100-2 receives the MBS session start notification from the gNB 200. For the DM 1, a paging message including a TMGI list is received as the MBS session start notification. On the other hand, doe the DM2, the relay UE 100-2 receives the MCCH change notification and thereafter receives the updated MCCH, and confirms that (MTCH scheduling information for) the TMGI is added in the MCCH.

In step S106, the relay UE 100-2 transmits the MBS session start information including the TMGI of the MBS session to be started to the remote UE 100-1. The relay UE 100-2 may include all the TMGIs (TMGIs of the sessions to be started) received in step S105 in the MBS session start information. The relay UE 100-2 may include, in the MBS session start information, only the TMGI of the MBS session in which the remote UE 100-1 is interested among the TMGIs (TMGIs of the sessions to be started) received in the step S105. Here, the relay UE 100-2 may transmit the MBS session start information using the layer-2 identifier of the remote UE 100-1 as target.

In step S107, the remote UE 100-1 may stop the reselection operation to another relay UE and maintain the currently selected relay UE 100-2 in response to receiving the MBS session start information from the relay UE 100-2 indicating the start of the MBS session in which the remote UE 100-1 is interested. The remote UE 100-1, in response to receiving the MBS session start information from the relay UE 100-2 indicating the start of the MBS session in which the remote UE 100-1 is interested, may start monitoring sidelink data transmission associated with the identifier (TMGI) of the MBS session of interest.

In step S108, the relay UE 100-2 receives the MBS data belonging to the MBS session from the gNB 200 over the downlink (Uu interface). The MBS delivery mode between the gNB 200 and the relay UE 100-2 may be the first delivery mode (DM 1) or the second delivery mode (DM 2). The MRB from the gNB 200 to the relay UE 100-2 may be PTM, PTP, or split bearer (split MRB). The MRB data from the gNB 200 to the relay UE 100-2 may be transmitted in the DRB.

In step S109, the relay UE 100-2 transmits (transfers) the MBS data received from the gNB 200 to the remote UE 100-1 over the sidelink (PC5 interface). Specifically, the relay UE 100-2 transmits the MBS data on the sidelink shared channel (SL-SCH) to the remote UE 100-1. The sidelink transmission mode from the relay UE 100-2 to the remote UE 100-1 may be unicast, groupcast or broadcast. The remote UE 100-1 receives the MBS data.

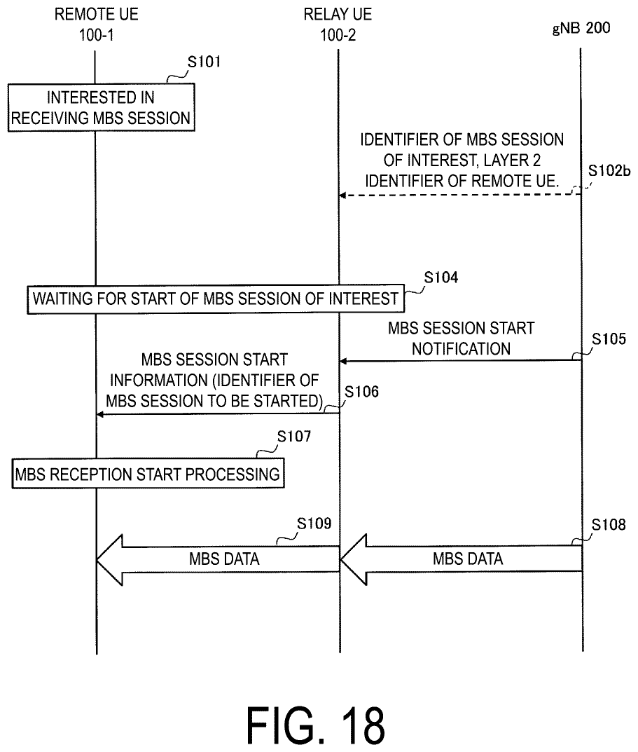

FIG. 18 is a diagram illustrating a variation of the operation illustrated in FIG. 17. For the multicast, the gNB 200 can grasp the MBS session (TMGI) in which the remote UE 100-1 is interested by acquiring the session join information from the CN 20.

In the variation, in step S102b, the gNB 200 transmits a message including the identifier (TMGI) of the MBS session in which the remote UE 100-1 is interested, to the relay UE 100-2. The message may include the layer-2 identifier of the remote UE 100-1 interested in receiving the MBS session.

### (5.2) MBS Data Transmission Operation in Sidelink

An MBS data transmission operation in the sidelink is described according to an embodiment.

In the sidelink communication between the remote UE 100-1 and the relay UE 100-2, the source layer-2 identifier (SRC) and the destination layer-2 identifier (DST) applied to the SL-SCH are set as follows.

The SRC is the layer-2 identifier of the transmission-side UE, whether unicast, groupcast or broadcast.

The DST is determined as follows.

For the unicast, the DST is the layer-2 identifier of the reception-side UE.

For the groupcast, when a ProSe layer-2 group identifier is configured for an application layer group identifier provided by the application layer, the DST is the ProSe layer-2 group identifier. For the groupcast, when the ProSe layer-2 group identifier is not configured for the application layer group identifier provided by the application layer, the DST is a transformed value from the application layer group identifier. The transmission-side UE selects the DST from the configuration of the mapping between the ProSe service type and the layer-2 identifier.

For the broadcast, the DST is a value configured for the transmission-side UE, and the DST is configured for the ProSe application.

### (5.2.1) First Operation Example

The remote UE 100-1 needs to grasp association between the identifier (TMGI) of the MBS session in which the remote UE 100-1 is interested and the layer-2 identifier. Specifically, the remote UE 100-1 needs to grasp which layer-2 identifier is associated with the TMGI of interest in order to receive only the target sidelink transmission (target SL-SCH transmission).

In the embodiment, the remote UE 100-1 receives, from the relay UE 100-2 or the gNB 200, association information (mapping information) in which the identifier (TMGI) indicating the MBS session (specifically, the MBS session in which the remote UE 100-1 is interested) and the destination layer-2 identifier are associated with each other. The remote UE 100-1 receives the MBS data belonging to the MBS session from the gNB 200 via the relay UE 100-2 based on the association information. Here, the remote UE 100-1 monitors the SL-SCH using the destination layer-2 identifier associated with the MBS session. This allows the remote UE 100-1 to appropriately receive only the target sidelink communication from the relay UE 100-2.

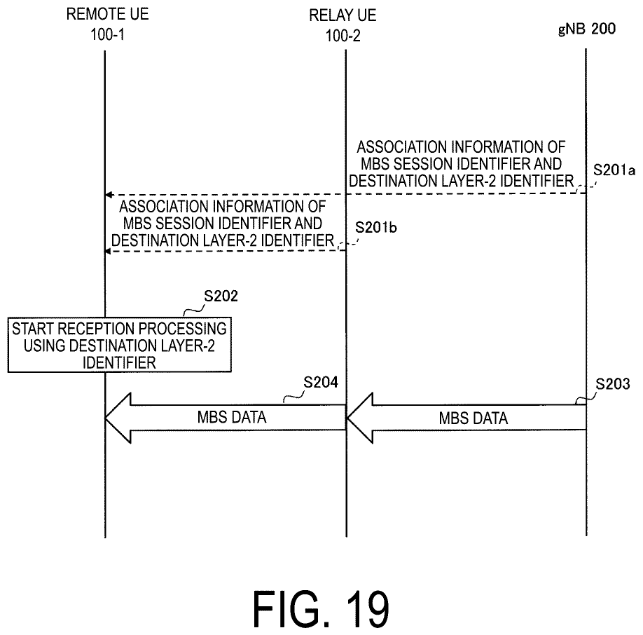

FIG. 19 is a diagram illustrating a first operation example of an MBS data transmission in the sidelink according to an embodiment. In the operation example, assume that the sidelink transmission mode from the relay UE 100-2 to the remote UE 100-1 is groupcast or broadcast.

In step S201a, the gNB 200 may transmit, to the remote UE 100-1 via the relay UE 100-2, the association information (mapping information) in which the identifier (TMGI) indicating the MBS session and the destination layer-2 identifier are associated with each other. The association information may include one or more sets of the TMGI and the destination layer-2 identifier. The gNB 200 may transmit an RRC message including the association information to the remote UE 100-1 via the relay UE 100-2.

In step S201b, the relay UE 100-2 may transmit, to the remote UE 100-1, the association information (mapping information) in which the identifier (TMGI) indicating the MBS session and the destination layer-2 identifier are associated with each other. The association information may include one or more sets of the TMGI and the destination layer-2 identifier. The relay UE 100-2 may transmit a PC5-RRC message, discovery message or PC5-S message including the association information to the remote UE 100-1.

Note that the gNB 200 or the relay UE 100-2 may transmit the association information only to the remote UE 100-1 interested in the MBS reception based on the MBS interest information described above or below.

In step S202, the remote UE 100-1 monitors the SL-SCH in which the destination layer-2 identifier (DST) is set in the AS layer (e.g., MAC layer) based on the association information received from the gNB 200 or the relay UE 100-2.

In step S203, the relay UE 100-2 receives the MBS data belonging to the MBS session from the gNB 200 over the downlink (Uu interface).

In step S204, the relay UE 100-2 transmits (transfers) the MBS data received from the gNB 200 to the remote UE 100-1 over the sidelink (PC5 interface). The remote UE 100-1 receives the MBS data.

In this operation example, the gNB 200 may transmit the association information (mapping information) in which the identifier (TMGI) indicating the MBS session and the destination layer-2 identifier are associated with each other to the relay UE 100-2, and the relay UE 100-2 may use the association information. When the remote UE 100-1 exists within the coverage of the gNB 200, the gNB 200 may directly transmit the association information to the remote UE 100-1 without involving the relay UE 100-2.

### (5.2.2) Second Operation Example

As described above, when using the groupcast in the sidelink, the ProSe layer-2 group identifier is used as the destination layer-2 identifier (DST). As such, the ProSe layer-2 group identifier may be associated with the TMGI. In this case, all UEs in this group are interested in this TMGI. The application layer group identifier may be associated with a TMGI.

Therefore, the upper layer (NAS, PC5-S, or application layer), to be more specific, the CN apparatus (e.g., AMF) or the ProSe server apparatus may associate the group identifier (ProSe layer-2 group identifier or application layer group identifier) with the TMGI and transmit the association information (mapping information) to the remote UE 100-1 and/or the relay UE 100-2.

The remote UE 100-1 and/or the relay UE 100-2 receives the association information in which the ProSe layer-2 group identifier or the application layer group identifier is associated with the identifier indicating the MBS session from the CN apparatus or the ProSe server apparatus. The remote UE 100-1 and/or the relay UE 100-2 may specify the destination layer-2 identifier associated with the MBS session based on the association information.

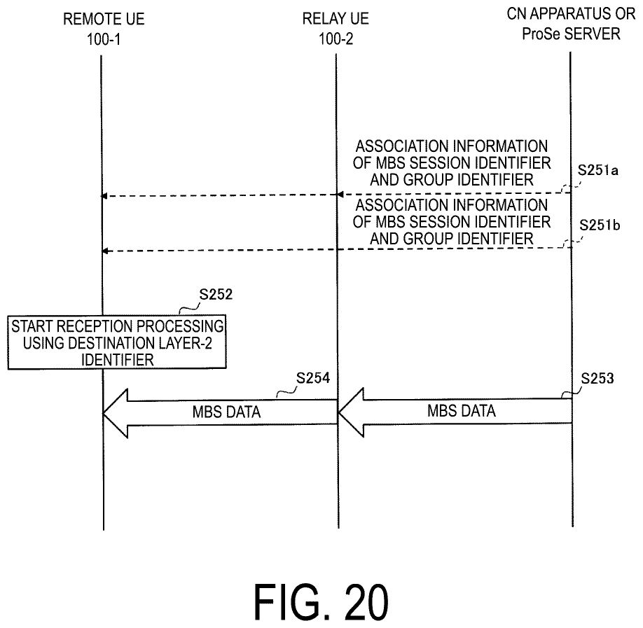

FIG. 20 is a diagram illustrating a second operation example of the MBS data transmission in the sidelink according to an embodiment. In the operation example, assume that the sidelink transmission mode from the relay UE 100-2 to the remote UE 100-1 is groupcast.

In step S251a, the CN apparatus or the ProSe server apparatus may transmit, to the relay UE 100-2, the association information (mapping information) in which the group identifier (ProSe layer-2 group identifier or application layer group identifier) is associated with the TMGI. The relay UE 100-2 may transfer the association information to the remote UE 100-1.

In step S251b, the CN apparatus or the ProSe server apparatus may transmit, to the remote UE 100-1 via the relay UE 100-2, the association information (mapping information) in which the group identifier (ProSe layer-2 group identifier or application layer group identifier) is associated with the TMGI. The association information may be transmitted to the remote UE 100-1 through the NAS signaling.

An upper layer (for example, NAS, PC5-S, or application layer) of the remote UE 100-1 (and the relay UE 100-2) may notify the AS layer of the association information as, for example, the mapping information between the DST and the TMGI. The upper layer may notify the AS layer as the DST of interest (DST requesting reception).

In step S252, the remote UE 100-1 monitors the SL-SCH in which the ProSe layer-2 group identifier (DST) is set.

In step S253, the relay UE 100-2 receives the MBS data belonging to the MBS session from the gNB 200 over the downlink (Uu interface).

In step S254, the relay UE 100-2 transmits (transfers) the MBS data received from the gNB 200 to the remote UE 100-1 over the sidelink (PC5 interface). The remote UE 100-1 receives the MBS data.

### (5.3) Relay UE Selection Operation by Remote UE

A relay UE selection operation by the remote UE 100-1 is described according to an embodiment.

Prior to a sidelink relay, the remote UE 100-1 selects the relay UE 100-2 used for the sidelink relay from among candidate relay UEs. The relay UE 100-2, after selecting the relay UE 100-2, may newly select (reselect) another UE 100 as a new relay UE 100-2.

In the embodiment, in such a relay UE selection operation, the remote UE 100-1 interested in the MBS reception gives priority to the relay UE 100-2 capable of transferring the MBS session in which the remote UE 100-1 is interested. That is, the remote ULE 100-1 selects the relay UE 100-2 capable of transferring a desired MBS session that the remote UE 100-1 is interested in receiving in preference to the relay UE 100-2 not transferring the desired MBS session. The remote UE 100-1 receives the MBS data belonging to the desired MBS session via the selected relay UE 100-2. This allows the remote UE 100-1 interested in the MBS reception to receive the MBS data belonging to the desired MBS session via the appropriate relay UE 100-2.

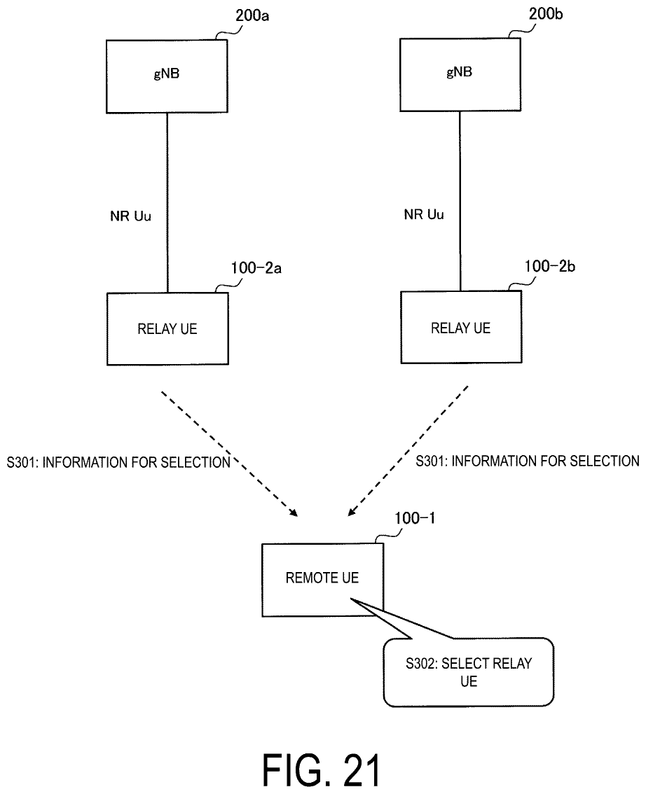

FIG. 21 is a diagram illustrating an example of the relay UE selection operation by the remote UE 100-1 according to an embodiment. FIG. 21 illustrates an example in which a relay UE 100 2a is connected to the gNB 200a via the Uu interface and a relay UE 100-2b is connected to the gNB 200b via the Uu interface. The relay UE 100-2a and the relay UE 100-2b are the candidate relay UEs for the remote UE 100-1.

In step S301, each of the candidate relay UEs (relay UE 100-2a and relay UE 100-2b) may transmit support information over the sidelink indicating whether to support the MBS session transfer. The remote UE 100-1 receives the support information from the candidate relay UE. In step S302, the remote UE 100-1 selects preferentially a candidate relay UE capable of transmitting the desired MBS session based on the received support information. The remote UE 100-1 receives the MBS data via the relay UE 100-2 selected from the candidate relay UEs. For example, assume that the relay UE 100-2a supports the MBS session transfer, and the relay UE 100-2b does not support the MBS session transfer. In this case, the remote UE 100-1 selects the relay UE 100-2a supporting the MBS session transfer based on the support information from each relay 100-2, and receives the MBS data via the relay UE 100-2a.

In step S301, each of the candidate relay UEs (relay UE 100-2a and relay UE 100-2b) may transmit an identifier (TMGI) indicating the MBS session the candidate relay UE can transfer over the sidelink. Each of the candidate relay UEs (relay UE 100-2a and relay UE 100-2b) may transmit a list of the identifiers (TMGIs) indicating MBS sessions the candidate relay UE can transfer. The remote UE 100-1 receives the identifier (TMGI). In step S302, the remote UE 100-1 selects preferentially the relay UE 100-2 capable of transferring the desired MBS session based on the received identifier (TMGI). The remote UE 100-1 receives the MBS data via the relay UE 100-2 selected from the candidate relay UEs. For example, assume that the identifier of the desired MBS session of the remote UE 100-1 is a TMGI #1, the identifier of the MBS session transferred by the relay UE 100-2a is the TMGI #1, and the identifier of the MBS session transferred by the relay UE 100-2b is a TMGI #2. In this case, the remote UE 100-1 selects the relay UE 100-2a supporting the desired MBS session transfer based on the MBS session identifier (TMGI) from each relay 100-2, and receives the MBS data via the relay UE 100-2a.

Note that when none of the candidate relay UE provides the desired MBS session, the remote UE 100-1 may transmit the identifier (TMGI) of the desired MBS session as the MBS interest information to the candidate relay Us as described above.

In step S301, the candidate relay UE may transmit a PC5-RRC message or discovery message including the support information and/or the MBS session identifier (TMGI) to the remote UE 100-1. The remote UE 100-1 may acquire the support information and/or the MBS session identifier (TMGI) of the candidate relay UE by receiving the PC5-RRC message or the discovery message. Note that the candidate relay UE may also transmit information (support information and/or MBS session identifier (TMGI)) about other candidate relay UEs to the remote UE 100-1. For example, the candidate relay UE may acquire information about the neighboring candidate relay UE from the gNB 200.

Prior to step S301, the candidate relay UE may specify the transferable MBS session based on the MBS reception configuration received from the gNB 200. For example, for a broadcast session, the candidate relay UE may specify the transferable MBS session (TMGI) by receiving and confirming the MCCH from the gNB 200 (serving cell). For a multicast session, the candidate relay UE may receive the RRC Reconfiguration from the gNB 200 (serving cell) and specify the transferable MBS session (TMGI) by confirming the TMGI of the configured MRB. When the relay UE 100-2 receives the MBS data from the gNB 200 in the DRB (by unicast), the candidate relay UE may specify the MBS session (TMGI) being received in the DRB.

In step S302, the remote UE 100-1 selects preferentially the relay UE 100-2 capable of transferring the desired MBS session in which the remote UE 100-1 is interested. For example, the remote UE 100-1 may select only the relay UE 100-2 capable of transmitting the desired MBS session as a candidate for relay UE selection. The remote UE 100-1 may measure reception qualities of radio signals from the respective candidate relay UEs and add an offset to the measurement values (for example, RSRP) to perform the relay UE selection. To be more specific, the remote UE 100-1 performs the relay UE selection by measuring and comparing the reception qualities of the radio signals (for example, sidelink communication signals or sidelink discovery signals) received from the respective candidate relay UEs. For example, the remote UE 100-1 selects the candidate relay UE with the best reception quality.

In this operation, the remote UE 100-1 adds an offset to the reception qualities of the candidate relay UEs capable of transferring the desired MBS session. This makes it easier to select the candidate relay UE capable of transferring the desired MBS session.

### (5.4) RRC Connection Operation by Relay UE

An RRC connection operation by the relay UE 100-2 is described according to an embodiment.

When the remote UE 100-1 is interested in the multicast session, the relay UE 100-2 may need to be in the RRC connected state to receive the MBS reception configuration (MRB configuration) from the gNB 200 because the multicast session is delivered in the first delivery mode (DM 1). Therefore, the relay UE 100-2 in the RRC idle state or the RRC inactive state may need to establish or resume an RRC connection in order to receive the multicast session.

In the embodiment, the relay UE 100-2 in the RRC idle state or RRC inactive state receives, from the remote UE 100-1, interest information (MBS interest information) indicating that the remote UE 100-1 is interested in receiving the multicast session. The relay UE 100-2, in response to receiving the interest information, performs connection processing of establishing or resuming the RRC connection to the gNB 200. This allows the relay UE 100-2 to receive the multicast session from the gNB 200 and transmit the MBS data belonging to the multicast session to the remote UE 100-1.

Here, the gNB 200 cannot distinguish the relay UE 100-2 interested only in the multicast reception from a normal UE upon the connection processing by the relay UE 100-2. Therefore, the gNB 200 may reject the connection processing by the relay UE 100-2 due to, for example, network congestion. Since the multicast reception consumes less resources compared to the normal UE (i.e. unicast), it is not preferable to reject the connection processing. Therefore, the relay UE 100-2 notifies the gNB 200 that the connection is dedicated to multicast reception in the connection processing. That is, the relay UE 100-2 notifies the gNB 200 that the multicast session transfer is the purpose by using a message transmitted from the relay UE 100-2 to the gNB 200 in the connection processing. Accordingly, the gNB 200 can avoid rejecting the connection processing.

For the multicast MRB (i.e., DM 1), high reliability is required, and thus it is preferable to ensure reliability also in the sidelink. Thus, the relay UE 100-2 maps the multicast radio bearer (MRB) corresponding to the multicast session to the unicast or groupcast of the sidelink between the remote UE 100-1 and the relay UE 100-2. For the sidelink, unicast transmission and groupcast transmission support HARQ feedback, and thus can ensure the higher reliability than the broadcast transmission not supporting the HARQ feedback.

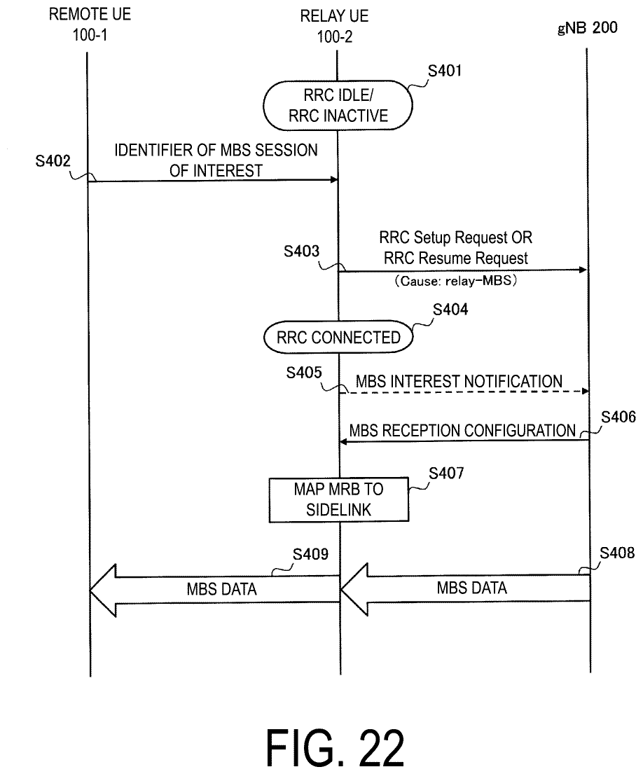

FIG. 22 is a diagram illustrating an operation example related to the RRC connection operation by the relay UE 100-2 according to an embodiment.

In step S401, the relay UE 100-2 is in the RRC idle state or the RRC inactive state. Note that a PC5-RRC connection may be established between the remote UE 100-1 and the relay UE 100-2.

In step S402, the remote UE 100-1 may transmit the identifier (TMGI) of the MBS session in which the remote UE 100-1 is interested, as MBS interest information, to the relay UE 100-2. The MBS interest information may include information indicating that the multicast session reception is of interest. For example, the MBS interest information may include information indicating that the TGI corresponds to a multicast session. The relay UE 100-2 grasps that the remote UE 100-1 is interested in receiving the multicast session based on the MBS interest information, and recognizes that relay UE 100-2 needs to transition to the RRC connected state.

In step S403, the relay UE 100-2 starts the connection processing with the gNB 200, specifically, the random access procedure. The relay UE 100-2 transmits an RRC Setup Request message or an RRC Resume Request message as a message 3 (Msg3) of the random access procedure. Here, the relay UE 100-2 includes in the Msg3 a Cause value (e.g., “relay-MBS”) indicating that the MBS transfer is intended. The Cause value may be information indicating that only the MBS reception is intended. The gNB 200 accepts the Msg3 (RRC Setup Request message or RRC Resume Request message), and transmits a Msg4 (RRC Setup message or RRC Resume message) to the relay UE 100-2. The relay UE 100-2 may use a random access preamble as a message 1 (Msg1) of the random access procedure to notify the gNB 200 that the MBS transfer (or MBS reception) is intended. For example, a physical random access channel (PRACH) resource for the notification may be prepared, and the relay UE 100-2 may perform the notification by transmitting the random access preamble on the PRACH resource.

As a result, in step S404, the relay UE 100-2 establishes or resumes the RRC connection, and transitions to the RRC connected state.

In step S405, the relay UE 100-2 may transmit, to the gNB 200, an MBS interest notification including the identifier (TMGI) of the MBS session (multicast session) that the remote UE 100-1 is interested in receiving.

In step S406, the gNB 200 transmits, to the relay UE 100-2, an RRC Reconfiguration message including the MBS reception configuration (multicast MRB configuration or the like) for the relay UE 100-2 to receive the multicast session.

In step S407, the relay UE 100-2 maps the MRB (multicast MRB) configured from the gNB 200 to the sidelink. Specifically, the relay UE 100-2 maps the multicast MRB to the unicast or groupcast of the sidelink. The mapping may be designated from gNB 200 to the relay UE 100-2, for example, in step S406.

In step S408, the relay UE 100-2 receives the MBS data belonging to the multicast session from the gNB 200 over the downlink (Uu interface).

In step S409, the relay UE 100-2 transmits the MBS data received from the gNB 200 to the remote UE 100-1 over the sidelink (PC5 interface). Specifically, the relay UE 100-2 transmits the MBS data to the remote UE 100-1 by unicast or groupcast. The remote UE 100-1 receives the MBS data.

In the above-described operation, the multicast (DM 1) is assumed, but for the broadcast MRB (DM 2), the relay UE 100-2 may map the MRB (broadcast MRB) to the broadcast of the sidelink. This is because the broadcast MRB does not support the HARQ feedback and the best effort may be provided.

### (5.5) Handover Operation of Relay UE

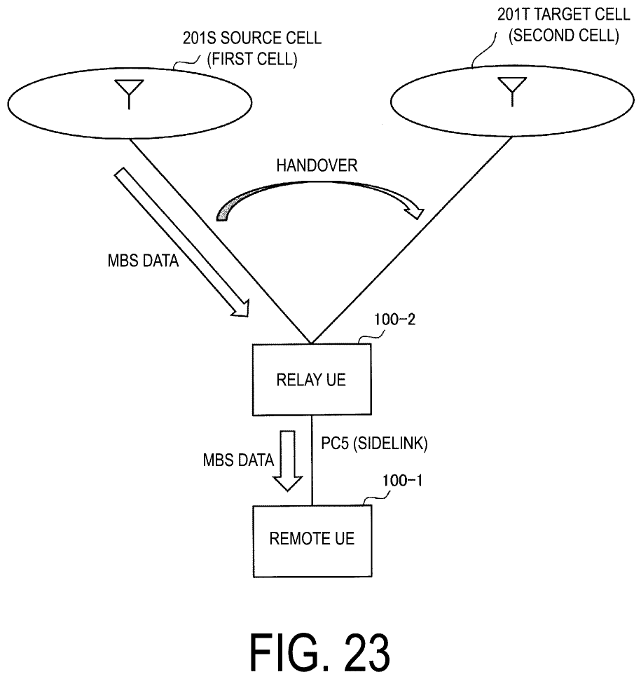

A handover operation of the relay UE 100-2 is described according to an embodiment. FIG. 23 is a diagram illustrating the handover operation of the relay UE 100-2 according to an embodiment.

The relay UE 100-2 transferring the MBS data from the gNB 200 to the remote UE 100-1 may be handed over from one cell (source cell 201S) to another cell (target cell 201T). Note that the source cell 201S and the target cell 201T may be managed by different gNBs 200. The source cell 201S and the target cell 201T may be managed by the same gNB 200. Such a handover includes the following two cases.

Case 1: The target cell 201T supports the MBS function but does not support a sidelink relay function.

Case 2: The target cell 201T supports the sidelink relay function but does not support the MBS function.

In these cases 1 and 2, depending on the handover of the relay UE 100-2, the remote UE 100-1 may not be able to continue to receive the MBS data. An operation example for the remote UE 100-1 to continue to receive the MBS data is described below.

### (5.5.1) First Operation Example

A first operation example is an operation example aimed at appropriately handing over the remote UE 100-1 in the case 1 described above.

In the first operation example, the relay UE 100-2 transfers the data received from the first cell (source cell 201S) supporting the sidelink relay function to the remote UE 100-1. The gNB 200 managing the first cell, in response to determining of handover of the relay UE 100-2 to the second cell (target cell 201T) not supporting the sidelink relay function, performs processing of causing the remote UE 100-1 to transmit a measurement report to the gNB 200. Based on the measurement report from the remote UE 100-1, the gNB 200-1 performs handover of the remote UE 100-1 before handover of the relay UE 100-2. This can avoid a problem of the remote UE 100-1 being not able to continue to receive the MBS data depending on the handover of the relay UE 100-2. Such an operation can be applied to all sidelink relays regardless of the MBS.

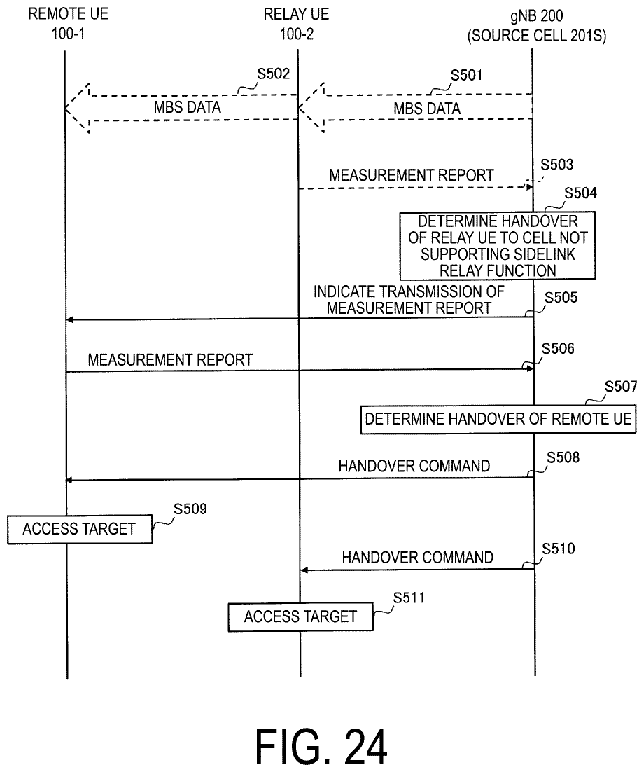

FIG. 24 is a diagram illustrating the first operation example of the handover of the relay UE 100-2 according to an embodiment. Prior to this operation, the gNB 200 managing the source cell 201S may acquire information on whether each of the neighboring cells of the source cell 201S supports the MBS and sidelink relay functions. The remote UE 100-1 (and the relay UE 100-2) may be configured with transmission of an event-triggered measurement report.

In step S501, the relay UE 100-2 may receive the MBS data belonging to the MBS session from the gNB 200 over the downlink (Uu interface).

In step S502, the relay UE 100-2 may transmit (transfer) the MBS data received from the gNB 200 to the remote UE 100-1 over the sidelink (PC5 interface).

In step S503, the relay UE 100-2 may transmit the measurement report including the measurement result of each cell to the source cell 201S (gNB 200), for example, in response to reception quality deterioration in the source cell 201S and/or reception quality improvement in the neighboring cell.

In step S504, the gNB 200 determines to hand over the relay UE 100-2 to the target cell not supporting the sidelink relay function. Such a determination may be to recognize that the relay UE 100-2 is likely to be handed over.

In step S505, the gNB 200-1 indicates transmission of the measurement report, to the remote UE 100-1 via the relay UE 100-2. Such an indication may be performed by way of an RRC message. For example, the indication may be transmitted from the gNB 200 to the relay UE 100-2, and then, transferred by the relay UE 100-2 to the remote UE 100-1. The indication may force the transmission of measurement report configured for the remote UE 100-1 to be triggered. Note that the gNB 200 may request the relay UE 100-2 to transmit the instruction, and the relay UE 100-2 may perform the indication to the remote UE 100-1.

In step S506, the remote UE 100-1 transmits the measurement report to the gNB 200. The measurement report includes the measurement result of each cell measured by the remote UE 100-1.

In step S507, the gNB 200 determines handover of the remote UE 100-1 based on the measurement report from the remote UE 100-1, and selects an appropriate target cell (or relay UE) as a target. Here, the gNB 200 may select a target that supports the MBS (and sidelink relay) functions.

In step S508, the gNB 200 transmits a handover command indicating handover to the determined target to the remote UE 100-1 via the relay UE 100-2. The handover command may be transmitted by way of an RRC message.

In step S509, the remote UE 100-1 performs access (connection processing) to the target in accordance with the received handover command. The remote UE 100-1 may receive the MBS data from the target.

In step S510, the gNB 200A transmits the handover command to the relay UE 100-2.

In step S511, the relay UE 100-2 performs access (connection processing) to the target in accordance with the received handover command.

### (5.5.2) Second Operation Example

A second operation example is an operation example for enabling the remote UE 100-1 to perform the MBS continuous reception in the case 2 described above.

In the second operation example, the relay UE 100-2 transfers the MBS data received by the relay UE 100-2 from the first cell (source cell 201S) supporting the MBS function to the remote UE 100-1. The gNB 200 managing the first cell, in response to determining the handover of the relay UE 100-2 to the second cell (target cell 201T) not supporting the MBS function, performs processing of causing the remote UE 100-1 to establish a PDU session for delivering the MBS data to the remote UE 100-1 by unicast. After the PDU session is established, the gNB 200 performs handover of the relay UE 100-2. The MBS data can be received from the CN 20 by unicast according to the PDU session, as illustrated in FIG. 6. Therefore, even when the handover of the relay UE 100-2 to the second cell (target cell 201T) not supporting the MBS function is performed, the remote UE 100-1 can continue to receive the MBS data using the established PDU session.

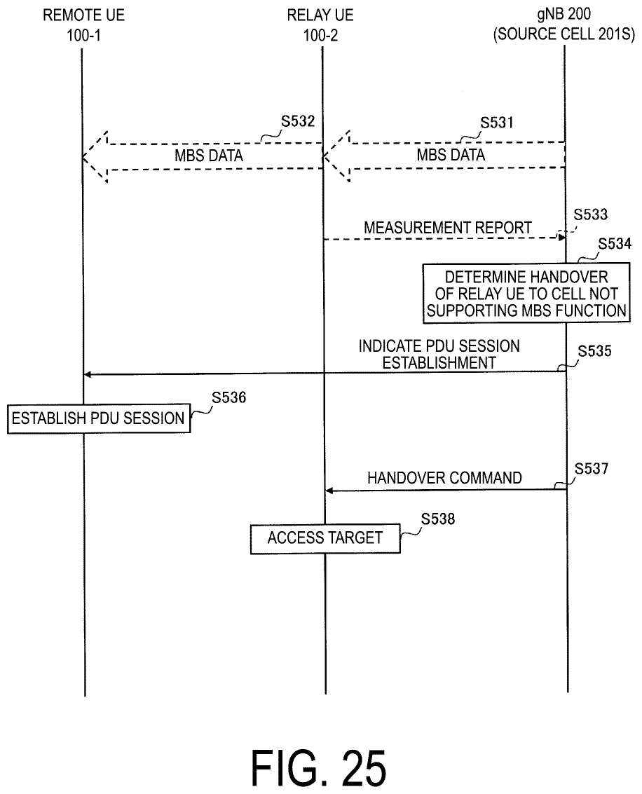

FIG. 25 is a diagram illustrating the second operation example of the handover of the relay UE 100-2 according to an embodiment. Prior to this operation, the gNB 200 managing the source cell 201S may acquire information on whether each of the neighboring cells of the source cell 201S supports the MBS and sidelink relay functions.

In step S531, the relay UE 100-2 may receive the MBS data belonging to the MBS session from the gNB 200 over the downlink (Uu interface).

In step S532, the relay UE 100-2 may transmit (transfer) the MBS data received from the gNB 200 to the remote UE 100-1 over the sidelink (PC5 interface).

In step S533, the relay UE 100-2 may transmit the measurement report including the measurement result of each cell to the source cell 201S (gNB 200), for example, in response to reception quality deterioration in the source cell 201S and/or reception quality improvement in the neighboring cell.

In step S534, the gNB 200 determines to hand over the relay UE 100-2 to the target cell not supporting the MBS function. Such a determination may be to recognize that the relay UE 100-2 is likely to be handed over.

Then in step S535, the gNB 200-1 indicates establishment of the PDU session for receiving the MBS, to the remote UE 100-1 via the relay UE 100-2. Such an indication may be performed by way of an RRC message. For example, the indication may be transmitted from the gNB 200 to the relay UE 100-2, and then, transferred by the relay UE 100-2 to the remote UE 100-1. The indication may include information (cause information) indicating that the PDU session establishment is caused by the handover of the relay UE 100-2. The AS of the remote UE 100-1 may notify the NAS of the remote UE 100-1 of the indication.

In Step S536, the remote UE 100-1 establishes the PDU session for receiving the MBS.

In step S537, the gNB 200 transmits a handover command to the relay UE 100-2.

In step S538, the relay UE 100-2 performs access (connection processing) to the target in accordance with the received handover command. Thereafter, the remote UE 100-1 continues to receive the MBS data using the PDU session established on the relay UE 100-2.

### (5.5.3) Third Operation Example

A third operation example is an operation example for enabling to hand over the remote UE 100-1 to the target cell 201T supporting the MBS function in order to avoid the case 2 described above.

In the third operation example, the relay UE 100-2 specifies an MBS session that the remote UE 100-1 is interested in receiving. The relay UE 100-2 transmits an identifier (TMGI) indicating the specified MBS session to the gNB 200. This allows the gNB 200 to grasp the MBS session that the remote UE 100-1 is interested in receiving, and thus, to select a target providing the MBS session as a target for the handover of the relay UE 100-2. Note that when a plurality of remote UEs 100-1 are subordinate to the relay UE 100-2, the relay UE 100-2 may transmit the identifier (TMGI) of the MBS session that each of the remote UEs 100-1 is interested in receiving to the gNB 200.

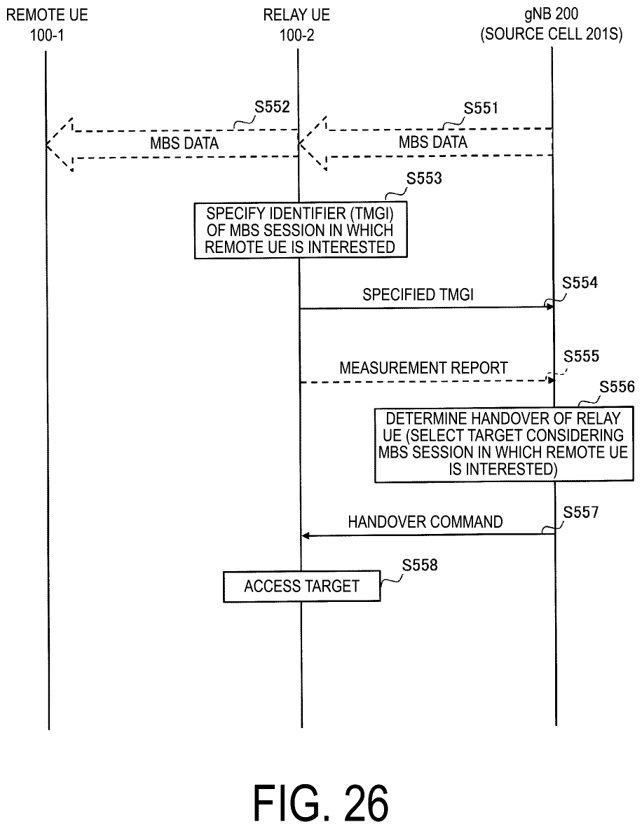

FIG. 26 is a diagram illustrating the third operation example of the handover of the relay UE 100-2 according to an embodiment. Prior to this operation, the gNB 200 managing the source cell 201S may acquire information on whether each of the neighboring cells of the source cell 201S supports the MBS and sidelink relay functions.

In step S551, the relay UE 100-2 may receive the MBS data belonging to the MBS session from the gNB 200 over the downlink (Uu interface).

In step S552, the relay UE 100-2 may transmit (transfer) the MBS data received from the gNB 200 to the remote UE 100-1 over the sidelink (PC5 interface).

In Step S553, the relay UE 100-2 specifies the identifier (TMGI) of the MBS session in which the remote UE 100-1 is interested. As described above, the relay UE 100-2 may perform specifying in step S553 from the information (MBS interest information) of the identifier (TMGI) of the MBS session of interest transmitted from the remote UE 100-1. The relay UE 100-2 may perform specifying in step S553 from the identifier (TMGI) of the MBS session that the relay UE 100-2 is currently transferring.

In step S554, the relay UE 100-2 transmits a message including the specified identifier (TMGI) to the gNB 200. The message may be an MBS interest notification (MII). The message may include information indicating that the identifier (TMGI) of the MBS session in which not the relay UE 100-2 but the remote UE 100-1 is interested.

In step S555, the relay UE 100-2 may transmit the measurement report including the measurement result of each cell to the source cell 201S (gNB 200), for example, in response to reception quality deterioration in the source cell 201S and/or reception quality improvement in the neighboring cell.

In step S556, the gNB 200 determines handover of the relay UE 100-2 to the target that provides the MBS session corresponding to the TMGI based on the identifier (TMGI) received from the relay UE 100-2 in step S554.

In step S557, the gNB 200 transmits a handover command to the relay UE 100-2.

In step S558, the relay UE 100-2 performs access (connection processing) to the target in accordance with the received handover command.

### (6) Other Embodiments

In the above-described embodiment, a single-hop case is assumed in which one relay UE 100-2 mediates between the gNB 200 and the remote UE 100-1, but the above-described embodiment may be applied to a multi-hop case in which a plurality of relay UEs 100-2 mediate between the gNB 200 and the remote UE 100-1. In the multi-hop case, the remote UE 100-1 may receive the MBS session start notification described above from the relay UE 100-2. The notification may be a PC5-RRC message including the MBS session start information. The notification may be a discovery message including MBS session start information.

The operation flows described above can be separately and independently implemented, and also be implemented in combination of two or more of the operation flows. For example, some steps of one operation flow may be added to another operation flow or some steps of one operation flow may be replaced with some steps of another operation flow.

In the embodiments described above, the example is described in which the base station is an NR base station (gNB); however, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node. In the embodiments described above, a relay UE may be read as an IAB node (relay node), and a remote UE may be read as a UE.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, System on a chip (SoC)).

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note

Features relating to the embodiments described above are described below as supplements.

(1)

A communication method for transmitting multicast broadcast service (MBS) data belonging to an MBS session from a base station to a remote user equipment via a relay user equipment, the communication method including,
a step of receiving, by a relay user equipment, an MBS session start notification indicating start of an MBS session from a base station, and
a step of transmitting, by the relay user equipment, an MBS session start information based on the MBS session start notification to a remote user equipment over a sidelink.
   (2)

The communication method according to (1) above, wherein
the step of receiving includes a step of receiving a paging message including an identifier of
the MBS session to be started, as the MBS session start notification from the base station.
   (3)

The communication method according to (1) above, wherein
the step of receiving includes a step of receiving a multicast control channel (MCCH) change notification indicating update of the MCCH and an updated MCCH, as the MBS session start notification from the base station.
   (4)

The communication method according to any one of (1) to (3) above, wherein the MBS session start information includes an identifier of the MBS session to be started.

(5)

The communication method according to any one of (1) to (3) above, further including, a step of receiving, by the relay user equipment, an identifier of a desired MBS session that the remote user equipment is interested in receiving, from the remote user equipment or the base station,
wherein the MBS session start information is information indicating, to the remote user equipment, start of the desired MBS session.
   (6)

The communication method according to any one of (1) to (4) above, further including, a step of receiving, by the relay user equipment, a layer-2 identifier assigned to the remote user equipment interested in receiving the MBS session, from the base station,
wherein the step of transmitting the MBS session start information includes a step of transmitting the MBS session start information to the remote user equipment using the layer-2 identifier.
   (7)

The communication method according to any one of (1) to (6) above, further including, a step of avoiding, by the remote user equipment in response to receiving the MBS session start information from the relay user equipment, reselection of a relay user equipment different from the former relay user equipment.

(8)

The communication method according to any one of (1) to (7) above, further including, a step of starting, by the remote user equipment, monitoring for sidelink data transmission from the relay user equipment, in response to receiving the MBS session start information from the relay user equipment.

(9)

A communication method for transmitting multicast broadcast service (MBS) data belonging to an MBS session from a base station to a remote user equipment via a relay user equipment, the communication method including,
a step of receiving, by a remote user equipment, association information in which an identifier indicating an MBS session and a destination layer-2 identifier are associated with each other from a relay user equipment or a base station, and
a step of receiving, by the remote user equipment, MBS data belonging to the MBS session from the base station via the relay user equipment based on the association information,
wherein the step of receiving the MBS data includes a step of monitoring a sidelink shared channel (SL-SCH) using the destination layer-2 identifier associated with the MBS session.
   (10)

A communication method for transmitting multicast broadcast service (MBS) data belonging to an MBS session from a base station to a remote user equipment via a relay user equipment, the communication method including,
a step of receiving, by a remote user equipment and/or a relay user equipment, association information in which a ProSe layer-2 group identifier or an application layer group identifier is associated with an identifier indicating an MBS session, from a core network apparatus or a server apparatus, and
a step of specifying, by the remote user equipment and/or the relay user equipment, a destination layer-2 identifier associated with the MBS session based on the association information.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method for transmitting multicast broadcast service (MBS) data belonging to an MBS session from a network node to a remote user equipment via a relay user equipment, the communication method comprising:
receiving, by a relay user equipment, an MBS session start notification indicating start of an MBS session from a network node; and
transmitting, by the relay user equipment, an MBS session start information based on the MBS session start notification to a remote user equipment over a sidelink.

2. The communication method according to claim 1, wherein
the receiving comprises receiving a paging message comprising an identifier of the MBS session to be started, as the MBS session start notification from the network node.

3. The communication method according to claim 1, wherein
the receiving comprises receiving a multicast control channel (MCCH) change notification indicating update of the MCCH and an updated MCCH, as the MBS session start notification from the network node.

4. The communication method according to claim 1, wherein
the MBS session start information comprises an identifier of the MBS session to be started.

5. The communication method according to claim 1, further comprising:
receiving, by the relay user equipment, an identifier of a desired MBS session that the remote user equipment is interested in receiving, from the remote user equipment or the network node,
wherein the MBS session start information is information indicating, to the remote user equipment, start of the desired MBS session.

6. The communication method according to claim 1, further comprising:
receiving, by the relay user equipment, a layer-2 identifier assigned to the remote user equipment interested in receiving the MBS session, from the network node,
wherein the transmitting of the MBS session start information comprises transmitting the MBS session start information to the remote user equipment using the layer-2 identifier.

7. The communication method according to claim 1, further comprising:
avoiding, by the remote user equipment in response to receiving the MBS session start information from the relay user equipment, reselection of a relay user equipment different from the former relay user equipment.

8. The communication method according to claim 1, further comprising:
starting, by the remote user equipment, monitoring for sidelink data transmission from the relay user equipment, in response to receiving the MBS session start information from the relay user equipment.

9. A relay user equipment configured to relay multicast broadcast service (MBS) data belonging to an MBS session from a network node to a remote user equipment, the relay user equipment comprising:
a receiver configured to receive an MBS session start notification indicating start of an MBS session from a network node, and
a transmitter configured to transmit an MBS session start information based on the MBS session start notification to the remote user equipment over a sidelink.

10. A communication method for transmitting multicast broadcast service (MBS) data belonging to an MBS session from a network node to a remote user equipment via a relay user equipment, the communication method comprising:
receiving, by a remote user equipment and/or a relay user equipment, association information in which a ProSe layer-2 group identifier or an application layer group identifier is associated with an identifier indicating an MBS session, from a core network apparatus or a server apparatus; and
specifying, by the remote user equipment and/or the relay user equipment, a destination layer-2 identifier associated with the MBS session based on the association information.
